(19) United States
(12) Patent Application Publication
(10) Pub. No.: US 2023/0202444 A1
(43) Pub. Date: Jun. 29, 2023

(54) BRAKE SYSTEM

(71) Applicant: DENSO CORPORATION, Kariya-city (JP)

(72) Inventors: Daisuke HOKUTO, Kariya-city (JP); Etsugo YANAGIDA, Kariya-city (JP); Soichi KINOUCHI, Kariya-city (JP); Tetsuo HARIU, Kariya-city (JP); Takuto KITA, Kariya-city (JP); Yuusuke YOSHIDA, Kariya-city (JP)

(21) Appl. No.: 18/179,053

(22) Filed: Mar. 6, 2023

Related U.S. Application Data
(63) Continuation of application No. PCT/JP2021/029370, filed on Aug. 6, 2021.

(30) Foreign Application Priority Data
Sep. 8, 2020 (JP) 2020-150711

(51) Int. Cl. B60T 13/66; B60T 7/06; B60T 7/04; B60T 7/12; B60T 8/171

(52) U.S. Cl. CPC B60T 13/662; B60T 7/06; B60T 7/042; B60T 7/12; B60T 8/171; B60T 13/142

(57) ABSTRACT

A brake pedal is operated by a pedal force of a driver. A sensor is capable of detecting a stroke amount of the brake pedal. A brake circuit generates braking force to apply a brake to a vehicle by applying hydraulic pressure to wheel cylinders provided to respective wheels. An electronic control device controls the braking force generated by the brake circuit based on an output signal from the sensor and a state of the vehicle. The electronic control device executes predetermined braking force control under which the braking force generated by the brake circuit is set to be predetermined braking force, when the stroke amount of the brake pedal is between a first threshold and a second threshold larger than the first threshold.

### CROSS REFERENCE TO RELATED APPLICATION

The present application is a continuation application of International Patent Application No. PCT/JP2021/029370 filed on Aug. 6, 2021, which designated the U.S. and claims the benefit of priority from Japanese Patent Application No. 2020-150711 filed on Sep. 8, 2020. The entire disclosures of all of the above applications are incorporated herein by reference.

### TECHNICAL FIELD

The present disclosure relates to a brake system installed in a vehicle.

### BACKGROUND

Conventionally, an electronic brake-by-wire system includes an electronic control device that controls braking of a vehicle.

### SUMMARY

According to an aspect of the present disclosure, a brake system includes a brake pedal, a sensor to detect a stroke amount of the brake pedal, and a control device to control a braking force of a vehicle based on an output signal from the sensor.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating a configuration of a brake system according to a first embodiment;

FIG. 2 is a side view of a brake device of the brake system according to the first embodiment;

FIG. 3 is a graph illustrating a relationship between a stroke amount of a brake pedal and braking force in the brake system according to the first embodiment;

FIG. 4A is a graph illustrating a relationship between time lapse and the stroke amount of the brake pedal at the time of vehicle braking, in the brake system according to the first embodiment;

FIG. 4B is a graph illustrating a relationship between time lapse and the braking force at the time of vehicle braking, in the brake system according to the first embodiment;

FIG. 4C is a graph illustrating a relationship between time lapse and acceleration/deceleration G at the time of vehicle braking, in the brake system according to the first embodiment;

FIG. 5 is a flowchart illustrating control processing executed by an ECU of the brake system according to the first embodiment;

FIG. 6A is a graph illustrating a relationship between time lapse and the stroke amount of the brake pedal at the time of vehicle braking, in a brake system according to a second embodiment;

FIG. 6B is a graph illustrating a relationship between time lapse and the braking force at the time of vehicle braking, in the brake system according to the second embodiment;

FIG. 6C is a graph illustrating a relationship between time lapse and acceleration/deceleration G at the time of vehicle braking, in the brake system according to the second embodiment;

FIG. 6D is a graph illustrating a relationship between time lapse and vehicle speed at the time of vehicle braking, in the brake system according to the second embodiment;

FIG. 7 is a flowchart illustrating control processing executed by an ECU of the brake system according to the second embodiment;

FIG. 8 is a diagram illustrating a state in which a stop line recognized by a stop recognition device of a vehicle in which a brake system according to a third embodiment is installed is displayed on a display screen of a meter panel;

FIG. 9A is a graph illustrating a relationship between time lapse and the stroke amount of the brake pedal at the time of vehicle braking, in the brake system according to the third embodiment;

FIG. 9B is a graph illustrating a relationship between time lapse and the braking force at the time of vehicle braking, in the brake system according to the third embodiment;

FIG. 9C is a graph illustrating a relationship between time lapse and acceleration/deceleration G at the time of vehicle braking, in the brake system according to the third embodiment;

FIG. 9D is a graph illustrating a relationship between time lapse and vehicle speed at the time of vehicle braking, in the brake system according to the third embodiment;

FIG. 10 is a flowchart illustrating control processing executed by an ECU of the brake system according to the third embodiment;

FIG. 11 is a cross-sectional view of a brake device of a brake system according to a fourth embodiment;

FIG. 12 is a graph illustrating an operation example of a load application device of the brake system according to the fourth embodiment;

FIG. 13 is a graph illustrating an operation example of the load application device of the brake system according to the fourth embodiment;

FIG. 14 is a cross-sectional view of a brake device of a brake system according to a fifth embodiment;

FIG. 15 is a graph illustrating an operation example of a load application device of a brake system according to a sixth embodiment;

FIG. 16 is a graph illustrating an operation example of a load application device of a brake system according to a seventh embodiment;

FIG. 17 is a graph illustrating an operation example of a load application device of a brake system according to an eighth embodiment;

FIG. 18 is a diagram illustrating how a display device installed in a vehicle displays a stroke amount, first threshold, and a second threshold of a brake pedal in a brake system according to a ninth embodiment;

FIG. 19 is a diagram illustrating an example of a design of a switch installed in a vehicle, in a brake system according to a tenth embodiment; and

FIG. 20 is a diagram illustrating a configuration of a brake system according to an eleventh embodiment.

### DETAILED DESCRIPTION

Hereinafter, examples of the present disclosure will be described.

According to an example of the present disclosure, a brake-by-wire system uses an electronic control device (hereinafter, referred to as ECU) to control driving of a hydraulic pressure generation device, such as a master cylinder, generating hydraulic pressure in a brake circuit in a brake circuit, based on an output signal from a stroke sensor that detects a stroke amount of a brake pedal. The stroke amount of the brake pedal is also referred to as a depression amount or an operation amount of the brake pedal. ECU stands for Electronic Control Unit.

A brake system according to an example includes a brake booster device that accelerates and decelerates a vehicle, a threshold changing unit that changes a threshold for the stroke amount of the brake pedal according to deceleration of the vehicle, and a brake control unit that controls a braking force (that is, brake force) so as to achieve target deceleration. The brake control unit determines whether the stroke amount of the brake pedal exceeds or falls short from the target deceleration computed by the ECU based on information of the stroke sensor, and controls the vehicle based on booster brake pressure requirement characteristics stored in advance in the ECU.

The brake system having an assumable configuration involves a relationship in which the braking force generated by the brake circuit nonlinearly increases relative to the stroke amount of the brake pedal. Therefore, when the stroke amount of the brake pedal varies due to variation in pedal force applied by the driver, the vehicle cannot be controlled with a stable braking force. If the stroke amount of the brake pedal varies due to the variation in the pedal force applied by the driver, the braking force generated by the brake circuit varies, resulting an occupant including the driver receiving unintended acceleration/deceleration G. Therefore, a driver who wants to decelerate the vehicle with a constant braking force is required to perform an intricate brake pedal operation such as continuously holding the brake pedal with a constant stroke amount in order to output the constant braking force. Thus, there is a problem in that the driver has to go through a highly stressful brake pedal operation which is a heavy burden.

According to an aspect of the present disclosure, a brake system is installable in a vehicle. The brake system comprises a brake pedal operable by a pedal force of a driver. The brake system further comprises a sensor capable of detecting a stroke amount of the brake pedal. The brake system further comprises a brake circuit configured to cause application of a hydraulic pressure to a wheel cylinder provided to a wheel of the vehicle to generate a braking force to brake the vehicle. The brake system further comprises an electronic control device configured to control the braking force generated by the brake circuit, based on an output signal from the sensor and a state of the vehicle. The electronic control device is configured to execute a braking force control to set the braking force generated by the brake circuit to a predetermined braking force, when the stroke amount of the brake pedal is between a predetermined first threshold and a predetermined second threshold, which is larger than the first threshold.

With this configuration, even when the pedal stroke amount of the brake pedal varies due to variation in pedal force applied to the brake pedal from the driver at the time of vehicle braking, the braking force control is executed, and the brake is applied to the vehicle with the predetermined braking force as long as the stroke amount is between the first threshold and the second threshold. Therefore, with the brake system, at the time of vehicle braking, the driver can achieve smooth braking through a simple brake pedal operation, instead of detailed adjustment on the brake pedal. Thus, the brake system can improve operability of a brake pedal and reduce the stress the driver feels when operating the brake pedal.

Hereinafter, embodiments of the present disclosure will be described with reference to the drawings. In the following embodiments, the same or equivalent portions are denoted by the same reference numerals, and the description thereof will be omitted.

### First Embodiment

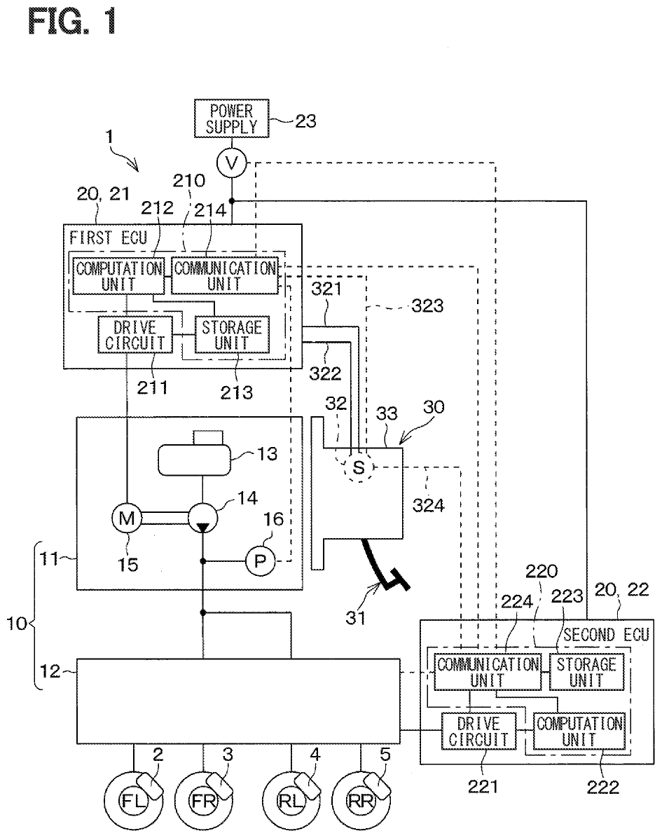

A first embodiment will be described with reference to FIG. 1 to FIG. 5. The brake system 1 of the present embodiment is a brake-by-wire system installed in a vehicle. The brake-by-wire system uses an electronic control device 20 to control driving of a hydraulic pressure generation device that generates a hydraulic pressure in a brake circuit 10, based on an output signal from a sensor 32 that detects a stroke amount θ of a brake pedal 31. In the following description, the electronic control device 20 is referred to as an ECU 20. ECU stands for Electronic Control Unit.

First, an example of a configuration of the brake system 1 will be described.

As illustrated in FIG. 1, the brake system 1 includes the brake circuit 10 that applies hydraulic pressure to wheel cylinders 2 to 5 provided to the respective wheels, the ECU 20 that controls driving of the brake circuit 10, and a brake device 30 operated by a driver.

The brake circuit 10 is a mechanism that generates braking force to apply a brake to the vehicle by applying the hydraulic pressure to the wheel cylinders 2 to 5 provided to the respective wheels. The brake circuit 10 includes a first brake circuit 11 and a second brake circuit 12.

The ECU 20 controls the driving of the brake circuit 10 based on the output signal from the sensor 32 of the brake device 30 and the state of the vehicle, to control the braking force generated by the brake circuit 10. The ECU 20 includes a first ECU 21 and a second ECU 22. The first ECU 21 and the second ECU 22 are not limited to be configured as a separate members as in FIG. 1, and may be integrally configured.

Of the wheel cylinders 2 to 5 provided to the respective wheels, the left front wheel cylinder 2 provided to the front left wheel drives a brake pad for the front left wheel, a right front wheel cylinder 3 provided to the right front wheel drives a brake pad for the right front wheel, a left rear wheel cylinder 4 provided to the left rear wheel drives a brake pad for the left rear wheel, and a right rear wheel cylinder 5 provided to the right rear wheel drives a brake pad for the right rear wheel.

The first brake circuit 11 of the brake circuit 10 generates hydraulic pressure in brake fluid flowing in a pipe, based on a control signal from the first ECU 21. The first brake circuit 11 raises the hydraulic pressure to raise the hydraulic pressure of the wheel cylinders 2 to 5 through the second brake circuit 12. Specifically, the first brake circuit 11 of the present embodiment includes a reservoir 13, a brake pump 14, a brake circuit motor 15, a pressure sensor 16, and the like.

The reservoir 13 stores the brake fluid. The brake circuit motor 15 is rotationally driven by a drive signal from the first ECU 21, and transmits the resultant torque to the brake pump 14. The brake pump 14 is driven by the torque transmitted from the brake circuit motor 15 to raise the pressure of the brake fluid supplied from the reservoir 13. The brake circuit motor 15 and the brake pump 14 correspond to an example of the hydraulic pressure generation device that generates the hydraulic pressure in the brake circuit 10. The hydraulic pressure of the brake fluid raised by the driving of the brake pump 14 is supplied from the first brake circuit 11 to the second brake circuit 12. The pressure sensor 16 outputs a signal corresponding to the hydraulic pressure of the brake fluid of the first brake circuit 11 to the first ECU 21.

The second brake circuit 12 is a circuit for performing normal control, ABS control, VSC control, and the like by controlling the hydraulic pressure to the wheel cylinders 2 to 5 based on a control signal from the second ECU 22. ABS stands for Anti-lock Braking System, and VSC stands for Vehicle Stability Control.

A power supply 23 supplies power to the first ECU 21, the second ECU 22, and the like. The first ECU 21 controls driving of the brake circuit motor 15 of the first brake circuit 11. The first ECU 21 includes a first microcomputer 210 and a first drive circuit 211. The first microcomputer 210 includes a computation unit 212 configured by a CPU, a storage unit 213 configured by a non-transitory tangible storage medium, and a communication unit 214 for communicating with a second microcomputer 220, sensors 16 and 32, and the like described below. The first microcomputer 210 outputs a drive signal to the first drive circuit 211. The first drive circuit 211 includes a switching element and the like (not illustrated), and supplies power to the brake circuit motor 15 based on the drive signal from the first microcomputer 210 to drive the first brake circuit 11.

The second ECU 22 controls driving of the second brake circuit 12. The second ECU 22 includes the second microcomputer 220 and a second drive circuit 221. The second microcomputer 220 includes a computation unit 222 configured by a CPU, a storage unit 223 configured by a non-transitory tangible storage medium, and a communication unit 224 for communicating with the first microcomputer 210, the sensors 16 and 32, and the like. The second microcomputer 220 outputs a drive signal to the second drive circuit 221. The second drive circuit 221 includes a switching element and the like (not illustrated), and drives an electromagnetic valve, a motor, and the like (not illustrated) of the second brake circuit 12 based on the drive signal from the second microcomputer 220.

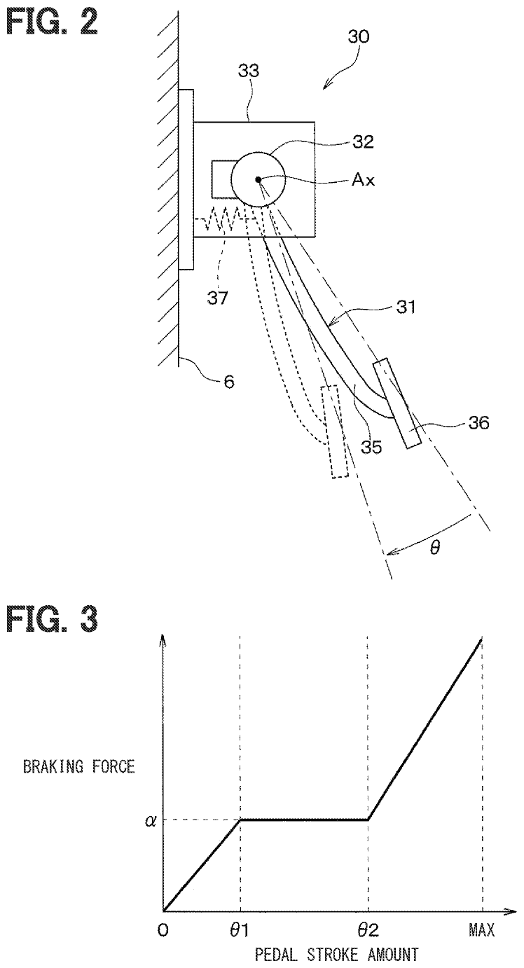

As illustrated in FIGS. 1 and 2, the brake device 30 includes a support 33, the brake pedal 31 operated by a pedal force applied by the driver, the sensor 32 that outputs a signal corresponding to the stroke amount θ of the brake pedal 31, and the like. The stroke amount θ of the brake pedal 31 is also referred to as a depression amount, an operation amount, of a pedal stroke amount θ of the brake pedal 31. In the following description, the stroke amount θ of the brake pedal 31 is referred to as “pedal stroke amount θ”.

The support 33 is attached to a part of the vehicle body on the front side of the cabin interior. Specifically, the support 33 is attached to, for example, a dash panel 6 which is a partition wall that separates the cabin interior from the cabin exterior such as an engine room of the vehicle. The dash panel 6 may be referred to as a bulkhead.

The brake pedal 31 includes an arm portion 35 and a pedal portion 36. One end portion of the arm portion 35 in the longitudinal direction is rotatably provided on the support 33. The pedal portion 36 is provided at the other end portion of the arm portion 35 in the longitudinal direction. When the driver applies the pedal force to the pedal portion 36, the pedal portion 36 and the arm portion 35 rotationally move about a rotation axis Ax provided at one end portion of the arm portion 35. In this manner, the brake pedal 31 is operated by the pedal force applied to the pedal portion 36 from the driver. Although not illustrated, the brake pedal 31 may be configured to translate in a vehicle front-rear direction instead of or together with the rotational movement about the rotation axis Ax.

The brake pedal 31 of the brake device 30 of the present embodiment is not mechanically connected to the hydraulic pressure generation device that generates hydraulic pressure in the brake circuit 10. Thus, the brake device 30 includes a spring 37 as a reaction force generating member that generates a reaction force against the pedal force applied to the brake pedal 31 from the driver (hereinafter, simply referred to as “reaction force from the brake pedal 31”). Specifically, the spring 37 has one end connected to the arm portion 35 of the brake pedal 31, and the other end connected to the inner wall of the support 33. As the spring 37, for example, any spring such as an equal interval spring, an unequal interval spring, or a two-stage spring can be used according to required pedal force characteristics. The spring 37 biases the brake pedal 31 toward the rear side of the cabin interior (that is, the driver seated on the driver's seat).

The sensor 32 detects the pedal stroke amount θ. As the sensor 32 of the present embodiment, an angle sensor is used that detects the rotation angle of the brake pedal 31 as the pedal stroke amount θ. The sensor 32 is disposed on the rotation axis Ax of the arm portion 35, and outputs a voltage signal corresponding to the rotation angle of the brake pedal 31. As the sensor 32, for example, a magnetic angle sensor 32 using a hall IC or the like can be used. Note that the sensor 32 is not limited thereto, and for example, a mechanical or optical sensor or the like may be used. Furthermore, the sensor 32 is not limited to one that detects the rotation angle of the brake pedal 31 as the pedal stroke amount θ, and for example, one that detects the movement amount of the brake pedal 31 may be used.

As illustrated in FIG. 1, the sensor 32 of the brake device 30 is connected with a sensor power supply wire 321, a sensor ground wire 322, a first output wire 323, and a second output wire 324. The sensor power supply wire 321, the sensor ground wire 322, and the first output wire 323 are each connected the first ECU 21 and the sensor 32. The second output wire 324 connects the second ECU 22 and the sensor 32 to each other. Thus, the sensor 32 outputs a signal corresponding to the pedal stroke amount θ to the first ECU 21 and the second ECU 22. The sensor power supply wire 321 and the sensor ground wire 322 are not limited to those in FIG. 1 connecting the first ECU 21 and the sensor 32 to each other, and may connect the second ECU 22 and the sensor 32 to each other.

Next, an operation of the brake system 1 will be described.

When the driver of the vehicle applies the pedal force to the brake pedal 31 to operate the brake pedal 31, a signal corresponding to the pedal stroke amount θ is output from the sensor 32 to the first ECU 21 and the second ECU 22.

The first ECU 21 drives the brake circuit motor 15 in order to decelerate the vehicle. As a result, the brake pump 14 is driven by the torque transmitted from the brake circuit motor 15 to raise the pressure of the brake fluid supplied from the reservoir 13. The resultant hydraulic pressure of the brake fluid is transmitted from the first brake circuit 11 to the second brake circuit 12.

In addition, the second ECU 22 executes normal control, ABS control, VSC control, and the like. The normal control is control for applying a brake based on the operation on the brake pedal 31 by the driver. For example, under the normal control, the second ECU 22 controls driving of each electromagnetic valve and the like of the second brake circuit 12 so that the hydraulic pressure is applied from the first brake circuit 11 to the wheel cylinders 2 to 5 through the second brake circuit 12. Therefore, the brake pads driven by the respective wheel cylinders 2 to 5 each come into frictional contact with the corresponding brake disc. Thus, a brake is applied to each wheel, whereby the vehicle decelerates.

In addition, for example, the second ECU 22 computes a slip rate of each of the left front wheel, the right front wheel, the left rear wheel, and the right rear wheel based on the speed of each wheel of the vehicle and the vehicle speed, and executes the ABS control based on the result of the computation. Under the ABS control, the hydraulic pressure applied to each of the wheel cylinders 2 to 5 is adjusted, to prevent each wheel from being locked.

In addition, for example, the second ECU 22 computes a sideslip state of the vehicle based on the yaw rate, the steering angle, the acceleration, speed of each wheel, the vehicle speed, and the like, and executes the VSC control based on the result of the computation. Under the VSC control, a control target wheel for stabilizing the vehicle turning is selected, and the hydraulic pressure to a wheel cylinder, of the wheel cylinders 2 to 5, corresponding to the wheel is raised, to prevent the skidding of the vehicle. Thus, the vehicle can travel stably.

Note that the second ECU 22 may execute collision avoidance control, regenerative cooperative control, and the like based on a signal from another ECU (not illustrated) in addition to the normal control, the ABS control, and the VSC control described above.

Furthermore, in the present embodiment, the first ECU 21 and the second ECU 22 execute braking force control described below. The braking force control is control under which the braking force generated by the brake circuit 10 is set to predetermined braking force when the pedal stroke amount θ detected by the output signal of the sensor 32 of the brake device 30 is within a predetermined control range. The braking force control can be performed by one or both of the first ECU 21 and the second ECU 22. Therefore, in the following description, the first ECU 21 and the second ECU 22 are simply referred to as the ECU 20.

FIG. 3 is a graph illustrating a relationship between the braking force generated by the brake circuit 10 (hereinafter, simply referred to as “braking force”) and the pedal stroke amount θ under the control executed by the ECU 20 of the brake system 1 of the present embodiment. In FIG. 3, the vertical axis represents the braking force, and the horizontal axis represents the pedal stroke amount θ.

As illustrated in the graph in FIG. 3, the ECU 20 executes the normal control when the pedal stroke amount θ is larger than 0 (that is, when the driver is applying no pedal force to the brake pedal 31) and smaller than a predetermined first threshold θ1. Under the normal control, the ECU 20 increases the braking force in accordance with the increase in the pedal stroke amount θ. Thus, while the vehicle is traveling, the driver can operate the brake pedal 31 with a relatively small pedal force to decelerate the vehicle and adjust the speed of the vehicle. At the time of vehicle braking, the driver can smoothly stop the vehicle while suppressing a change in acceleration felt by the occupant on his or her body and rocking of the body at the time of stopping the vehicle by reducing the pedal stroke amount θ to be smaller than the first threshold θ1 slightly before the vehicle stops.

When the pedal stroke amount θ is equal to or larger than the predetermined first threshold θ1 and equal to or smaller than a predetermined second threshold θ2, the ECU 20 executes the braking force control under which the braking force is set to be predetermined braking force. In the present embodiment, the ECU 20 executes “constant braking force control” for maintaining the braking force at a predetermined constant value α as the braking force control. At the time of vehicle braking, the pedal stroke amount θ may vary due to variation in the pedal force applied by the driver on the brake pedal 31. Also in this case, when the pedal stroke amount θ is within the range between the predetermined first threshold θ1 and the predetermined second threshold θ2, the constant braking force control is executed, whereby a brake is applied to the vehicle with predetermined braking force. Therefore, the driver can achieve smooth braking through a simple brake pedal operation, instead of detailed adjustment on the brake pedal 31. The predetermined value a of the constant braking force may be set and stored in the ECU 20 in advance, or may be set by the ECU 20 to be an appropriate value based on the vehicle speed, the magnitude of deceleration G, and the like.

In the following description, the predetermined first threshold θ1 is simply referred to as “first threshold θ1”, and the predetermined second threshold θ2 is simply referred to as “second threshold θ2”. The first threshold θ1 is set to a value smaller than half of the entire range of the pedal stroke amount. Thus, by applying a relatively small pedal force to the brake pedal 31, the driver can continue the execution of the braking force control with the pedal stroke amount θ maintained between the first threshold θ1 and the second threshold θ2 (that is, braking force control range).

The ECU 20 executes the normal control when the pedal stroke amount θ is larger than the second threshold θ2 and equal to or smaller than the maximum value. Also under the normal control, the ECU 20 increases the braking force in accordance with the increase in the pedal stroke amount θ. As a result, at the time of vehicle braking, the driver can stop the vehicle at any stopping position, by increasing the pedal force applied to the brake pedal 31 to increase the pedal stroke amount θ over the second threshold θ2. In addition, also under a situation requiring a sudden stop or a sudden deceleration such as sudden jumping out or another vehicle cutting in while the vehicle is traveling or a brake is being applied to the vehicle, the driver can suddenly stop or suddenly decelerate the vehicle by increasing the pedal stroke amount θ over the second threshold θ2.

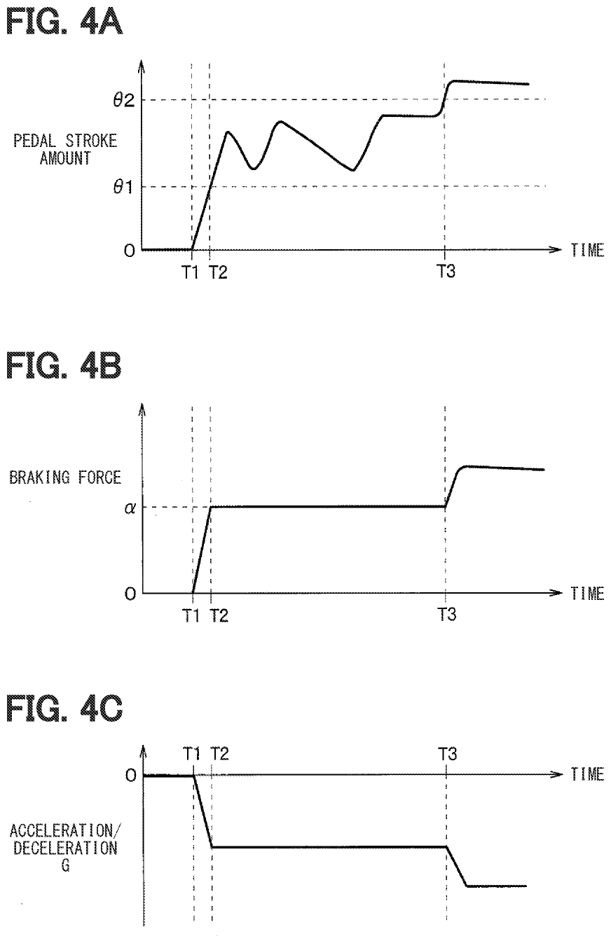

Next, a state at the time of vehicle braking with the constant braking force control executed by the ECU 20 of the present embodiment is illustrated in FIG. 4A to FIG. 4C. FIG. 4A to FIG. 4C all illustrate braking for the same vehicle, and all have the horizontal axis representing the same time lapse.

FIG. 4A illustrates how the pedal stroke amount θ changes at the time of vehicle braking. As illustrated in FIG. 4A, at a time point T1, the driver starts applying the pedal force to the brake pedal 31 in order to apply a brake to the vehicle. At a time point T2, the pedal stroke amount θ reaches or exceeds the first threshold θ1. From the time point T2 to a time point T3, the pedal stroke amount θ changes between the first threshold θ1 and the second threshold θ2. Although not illustrated, the pedal stroke amount θ may be kept substantially constant between the first threshold θ1 and the second threshold θ2 from the time point T2 to the time point T3. The pedal stroke amount θ is larger than the second threshold θ2 after the time point T3. Then, the vehicle stops.

FIG. 4B illustrates how the braking force changes at the time of vehicle braking. From the time point T1 to the time point T2, the braking force increases with the pedal stroke amount θ. Since the pedal stroke amount θ is between the first threshold θ1 and the second threshold θ2 from the time point T2 to the time point T3, the ECU 20 executes the constant braking force control to keep the braking force constant. After the time point T3, the pedal stroke amount θ is larger than the second threshold θ2, and thus the constant braking force control is deactivated, and the braking force corresponding to the pedal stroke amount θ is obtained.

FIG. 4C illustrates how the acceleration/deceleration G changes at the time of vehicle braking. From the time point T1 to the time point T2, the deceleration G increases with the braking force. In the present specification, the increase in the deceleration G means an increase in the absolute value of the deceleration G. Between the time point T2 and the time point T3, the braking force is maintained to be constant, and thus the deceleration G is constant. The deceleration G increases due to an increase in braking force at and after the time point T3.

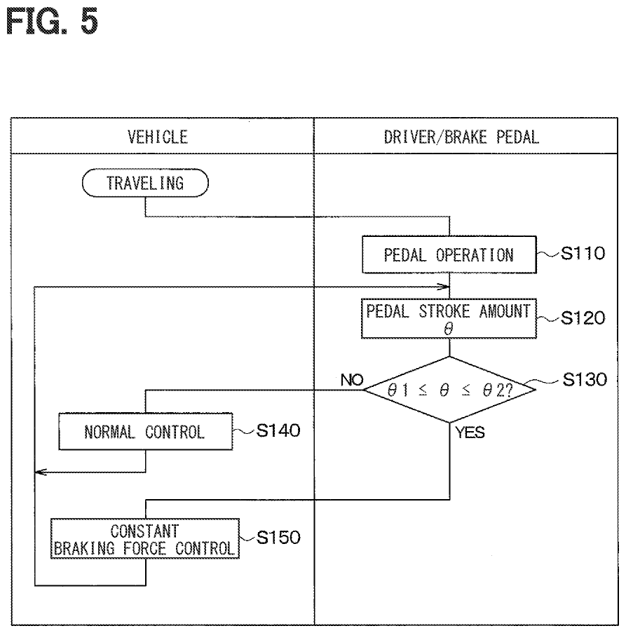

Next, control processing executed by the ECU 20 according to the present embodiment will be described with reference to a flowchart in FIG. 5.

The ECU 20 executes this control processing while the vehicle is traveling.

In step S110 in FIG. 5, in order to apply a brake to the vehicle, the driver applies pedal force to the brake pedal 31 and performs a depressing operation on the brake pedal 31. The sensor 32 of the brake device 30 outputs a signal corresponding to the pedal stroke amount θ to the ECU 20.

In step S120, the ECU 20 detects the pedal stroke amount θ from the output signal from the sensor 32.

Next, in step S130, the ECU 20 determines whether the pedal stroke amount θ is between the first threshold θ1 and the second threshold θ2. When the ECU 20 determines that the pedal stroke amount θ is not between the first threshold θ1 and the second threshold θ2 (that is, determines NO in step S130), the processing proceeds to step S140.

In step S140, the ECU 20 executes the normal control under which the braking force increases with the pedal stroke amount θ.

On the other hand, when the ECU 20 determines that the pedal stroke amount θ is between the first threshold θ1 and the second threshold θ2 in the processing in step S130 (that is, determines YES in step S130), the processing proceeds to step S150.

In step S150, the ECU 20 executes braking force control in which the braking force is set to predetermined braking force. Specifically, the ECU 20 executes the constant braking force control under which the braking force is kept constant.

Then, the ECU 20 repeatedly executes the processing described in steps S120 to S150, at a predetermined control time interval while the vehicle is traveling.

The brake system 1 of the first embodiment described above provides the following advantageous effects.

When the pedal stroke amount θ is larger than the predetermined first threshold θ1 and smaller than the predetermined second threshold θ2, the ECU 20 of the brake system 1 of the first embodiment executes the braking force control under which the braking force is set to predetermined braking force. With this configuration, even when the pedal stroke amount θ varies due to the driver's depressing operation at the time of vehicle braking, the braking force control is executed, and a brake is applied to the vehicle with the predetermined braking force as long as the pedal stroke amount θ is within the range between the first threshold θ1 and the second threshold θ2. Therefore, with the brake system 1, at the time of vehicle braking, the driver can achieve smooth braking through a simple brake pedal operation, instead of detailed adjustment on the brake pedal 31. Thus, the brake system 1 can improve operability of the brake pedal 31 and reduce the stress the driver feels when operating the brake pedal 31.

The brake system 1 of the first embodiment described above can further provide the following advantageous effects.

(1) The braking force control executed by the ECU 20 is the constant braking force control under which the braking force is set to be constant. With this configuration, even if the driver does not keep the pedal stroke amount θ constant, the deceleration G is kept constant at the time of vehicle braking, whereby smooth braking is achieved. Therefore, ride comfort at the time of vehicle braking can be improved.

### Second Embodiment

A second embodiment will be described. The second embodiment is obtained by partially changing the braking force control executed by the ECU 20 in the first embodiment, and the other configuration is the same as that in the first embodiment. Thus, only the part different from the first embodiment will be described.

Before describing the second embodiment, a general operation by the driver on the brake pedal 31 will be described.

Generally, when stopping the vehicle, in order to reduce a change in acceleration felt by the body of an occupant and rocking of the body, the driver reduces the depression amount of the brake pedal 31 immediately before the vehicle stops to reduce the deceleration G for stopping the vehicle smoothly. However, such a detailed brake pedal operation by the driver may be stressful to the driver.

Therefore, the ECU 20 of the brake system 1 of the second embodiment executes the following control. Specifically, when the pedal stroke amount θ is between the first threshold θ1 and the second threshold θ2 and the vehicle speed exceeds a predetermined vehicle speed threshold Th_v at the time of vehicle braking, the ECU 20 executes first braking force control under which the braking force is set to predetermined braking force. When the pedal stroke amount θ is between the first threshold θ1 and the second threshold θ2 and the vehicle speed falls below the predetermined vehicle speed threshold Th_v, the ECU 20 executes second braking force control under which the braking force is changed to braking force smaller than the braking force under the first braking force control. Thus, the braking force decreases slightly before the vehicle stops to reduce the deceleration G of the vehicle, whereby the vehicle smoothly stops. The control executed by the ECU 20 according to the second embodiment will be described below in detail.

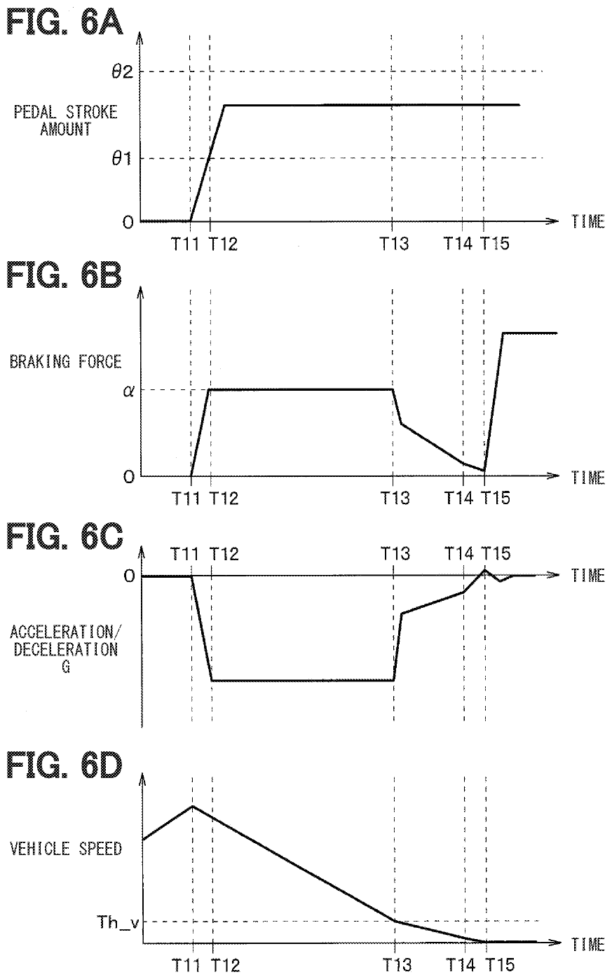

A state of vehicle braking with the constant braking force control executed by the ECU 20 of the second embodiment is illustrated in FIG. 6A to FIG. 6D. FIG. 6A to FIG. 6D all illustrate braking for the same vehicle, and all have the horizontal axis representing the same time lapse.

FIG. 6A illustrates how the pedal stroke amount θ changes at the time of vehicle braking. As illustrated in FIG. 6A, at a time point T11, the driver starts applying the pedal force to brake pedal 31 in order to apply a brake to the vehicle. At a time point T12, the pedal stroke amount θ reaches or exceeds the first threshold θ1. From the time point T12 to a time point T15 at which the vehicle stops, the pedal stroke amount θ is between the first threshold θ1 and the second threshold θ2. Although not illustrated, the pedal stroke amount θ only needs to be between the first threshold θ1 and the second threshold θ2 from the time point T12 to the time point T15, and thus may vary between the thresholds. In FIG. 6A, the pedal stroke amount θ stays between the first threshold θ1 and the second threshold θ2 after the vehicle has stopped at the time point T15.

FIG. 6B illustrates how the braking force changes at the time of vehicle braking. From the time point T11 to the time point T12, the braking force increases with the pedal stroke amount θ. As illustrated in FIG. 6D, the vehicle speed is higher than the predetermined vehicle speed threshold Th_v before a time point T13, and the vehicle speed becomes lower than the predetermined vehicle speed threshold Th_v at or after the time point T13. Thus, between the time point T12 and the time point T13, the pedal stroke amount θ is between the first threshold θ1 and the second threshold θ2 as illustrated in FIG. 6A, and the vehicle speed is higher than the predetermined vehicle speed threshold Th_v as illustrated in FIG. 6D. Therefore, between the time point T12 and the time point T13, the ECU 20 executes the first braking force control to set the braking force to the predetermined braking force as illustrated in FIG. 6B. Under the first braking force control, the constant braking force control for setting the braking force constant is executed as in the first embodiment, whereby the braking force is kept constant.

After the time point T13, the pedal stroke amount θ is between the first threshold θ1 and the second threshold θ2 as illustrated in FIG. 6A, and the vehicle speed is lower than the predetermined vehicle speed threshold Th_v as illustrated in FIG. 6D, and thus the second braking force control is executed by the ECU 20. Under the second braking force control, the braking force is changed to braking force smaller than the braking force under the first braking force control. Under the second braking force control illustrated in FIG. 6B, the braking force gradually decreases with the lapse of time after the time point T13. Then, after a time point T14, the decrease rate of the braking force is further reduced immediately before the vehicle stops. When the vehicle stops at the time point T15, the braking force increases to keep the vehicle in the stopped state.

FIG. 6C illustrates how the acceleration/deceleration G changes at the time of vehicle braking. From the time point T11 to the time point T12, the deceleration G increases with the braking force. Between the time point T12 and the time point T13, the braking force is maintained to be constant, and thus the deceleration G is constant. The deceleration G decreases due to the reduction in the braking force after the time point T13. After the time point T14, the decrease rate of the braking force is further reduced immediately before the vehicle stops, and thus the deceleration G is further reduced. Therefore, the acceleration/deceleration G before and after the vehicle stops at the time point T15 is extremely small.

FIG. 6D illustrates how the vehicle speed changes at the time of vehicle braking. The vehicle speed decreases from the time point T11 in response to an increase in the braking force. Then, the vehicle speed becomes smaller than the predetermined vehicle speed threshold Th_v at the time point T13. Therefore, the second braking force control is executed at the time point T13 and after to reduce the braking force. Thus, the decrease rate of the vehicle speed after the time point T13 is lower than the decrease rate of the vehicle speed before the time T13. Then, the vehicle speed becomes 0 at the time point T15, and the vehicle stops.

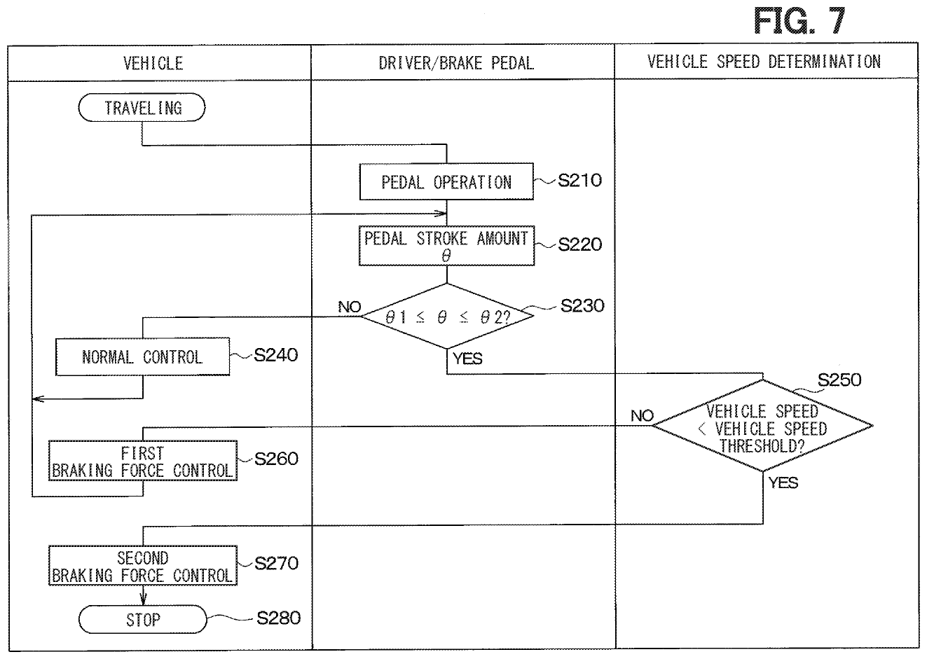

Next, control processing executed by the ECU 20 according to the second embodiment will be described with reference to a flowchart in FIG. 7.

The ECU 20 executes this control processing while the vehicle is traveling.

In step S210 in FIG. 7, in order to apply a brake to the vehicle, the driver applies pedal force to the brake pedal 31 and performs a depressing operation on the brake pedal 31. The sensor 32 of the brake device 30 outputs a signal corresponding to the pedal stroke amount θ to the ECU 20.

In step S220, the ECU 20 detects the pedal stroke amount θ from the output signal from the sensor 32.

Next, in step S230, the ECU 20 determines whether the pedal stroke amount θ is between the first threshold θ1 and the second threshold θ2. When the ECU 20 determines that the pedal stroke amount θ is not between the first threshold θ1 and the second threshold θ2 (that is, determines NO in step S230), the processing proceeds to step S240.

In step S240, the ECU 20 executes the normal control under which the braking force increases with the pedal stroke amount θ.

On the other hand, when the ECU 20 determines that the pedal stroke amount θ is between the first threshold θ1 and the second threshold θ2 in the processing in step S230 (that is, determines YES in step S230), the processing proceeds to step S250.

Next, in step S250, the ECU 20 determines whether the vehicle speed is lower than the predetermined vehicle speed threshold Th_v. When the ECU 20 determines that the vehicle speed is higher than the predetermined vehicle speed threshold Th_v (that is, determines NO in step S250), the processing proceeds to step S260.

In step S260, the ECU 20 executes the first braking force control. The first braking force control is the constant braking force control under which the braking force is set to be constant. Then, the ECU 20 repeatedly executes the processing described in steps S220 to S260, at a predetermined control time interval.

On the other hand, when the ECU 20 determines that the vehicle speed is lower than the predetermined vehicle speed threshold Th_v in step S250 (that is, determines YES in step S250), the processing proceeds to step S270.

In step S270, the ECU 20 executes the second braking force control. Under the second braking force control, the braking force is changed to braking force smaller than the braking force under the first braking force control. The braking force of the second braking force control is controlled to gradually decrease with the lapse of time to make the vehicle smoothly stop. The second braking force control is executed until the vehicle speed becomes 0 and the vehicle stops in step S280 following step S270.

The brake system 1 of the second embodiment described above also provides the same advantageous effects as those of the first embodiment, with the configuration and operation similar to those of the first embodiment. Furthermore, the second embodiment can provide the following advantageous effects.

(1) In the second embodiment, when the pedal stroke amount θ is between the first threshold θ1 and the second threshold θ2 and the vehicle speed exceeds the predetermined vehicle speed threshold Th_v, the ECU 20 executes the first braking force control under which the braking force produced by the brake circuit 10 is set to predetermined braking force. When the pedal stroke amount θ is between the predetermined first threshold θ1 and the predetermined second threshold θ2 and the vehicle speed falls below the predetermined vehicle speed threshold Th_v, the ECU 20 executes the second braking force control under which the braking force is changed to braking force smaller than the braking force under the first braking force control.

In the brake system 1 of the second embodiment with this configuration, the ECU 20 switches from the first braking force control to the second braking force control, when the vehicle speed drops below the predetermined vehicle speed threshold Th_v at the time of vehicle braking. Thus, the second braking force control is executed and the braking force decreases slightly before the vehicle stops to reduce the deceleration G of the vehicle, whereby the vehicle smoothly stops. Therefore, the brake system 1 does not require a detailed brake pedal operation by the driver to stop the vehicle, and enables a change in acceleration felt by the body of an occupant and rocking of the body when the vehicle is stopped, with a simple brake pedal operation. As a result, the brake system 1 can improve operability of the brake pedal 31 and reduce the stress the driver feels when operating the brake pedal 31.

### Third Embodiment

A third embodiment will be described. The third embodiment is obtained by partially changing the braking force control executed by the ECU 20 in the first embodiment and the like, and the other configuration is the same as that in the first embodiment and the like. Thus, only the part different from the first embodiment and the like will be described.

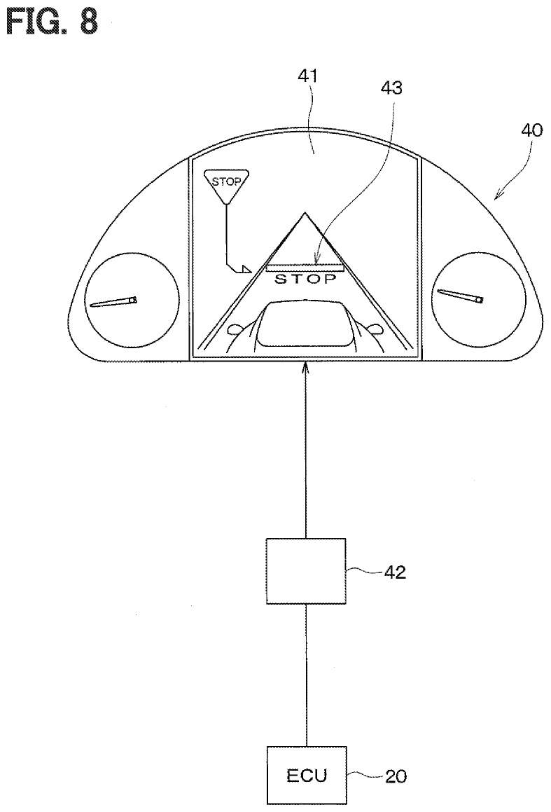

As illustrated in FIG. 8, a stop recognition device 42 that recognizes a sign or an object in front of the vehicle is installed in the vehicle in which the brake system 1 of the third embodiment is installed. The stop recognition device includes an ADAS device such as an in-vehicle camera or an infrared radar. ADAS stands for Advanced Driver Assistance Systems.

The stop recognition device 42 can recognize a road condition in front of the vehicle and determine whether a sign or an object requiring the vehicle to stop is present in a predetermined range in front of the vehicle. Note that the sign requiring the vehicle to stop is, for example, a stop line 43, and the object requiring the vehicle to stop is, for example, another vehicle that has stopped or slowing down in front of the vehicle. In the following description, the sign or the object requiring the vehicle to stop present in the predetermined range in front of the vehicle is referred to as “vehicle stop information”.

In the vehicle in which the brake system 1 of the third embodiment is installed, a display screen 41 may be provided at the center of a meter panel 40. In this case, the stop recognition device 42 can display a condition in front of the vehicle on the display screen 41. FIG. 8 illustrates an example of this, that is, a state in which the stop line 43 in front of the vehicle recognized by the stop recognition device 42 is displayed on the display screen 41. In the vehicle in which the brake system 1 of the third embodiment is installed, the stop recognition device 42 is an essential configuration, but the display screen 41 is not. That is, the display screen 41 may or may not be installed.

The ECU 20 of the brake system 1 of the third embodiment activates an automatic stop mode for stopping the vehicle by automatically controlling the driving of the brake circuit 10 based on the information transmitted from the stop recognition device 42. Specifically, the ECU 20 activates the automatic stop mode when the pedal stroke amount θ is between the first threshold θ1 and the second threshold θ2 and vehicle stop information is in the predetermined range in front of the vehicle. When the automatic stop mode is activated, the vehicle automatically stops traveling at the target stopping position without requiring the driver to operate the brake pedal 31. This control will be described in detail below.

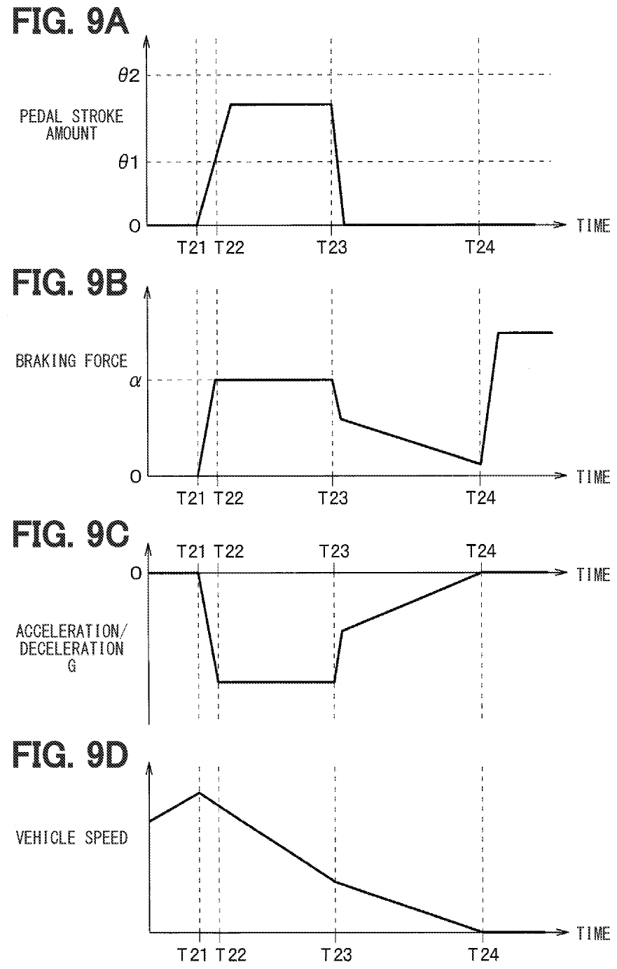

A state of vehicle braking with the constant braking force control and the automatic stop mode executed and activated by the ECU 20 of the third embodiment is illustrated in FIG. 9A to FIG. 9D. FIG. 9A to FIG. 9D all illustrate braking for the same vehicle, and all have the horizontal axis representing the same time lapse.

FIG. 9A illustrates how the pedal stroke amount θ changes at the time of vehicle braking. As illustrated in FIG. 9A, at a time point T21, the driver starts applying the pedal force to brake pedal 31 in order to apply a brake to the vehicle. At a time point T22, the pedal stroke amount θ reaches or exceeds the first threshold θ1. From the time point T22 to a time point T23, the pedal stroke amount θ is between the first threshold θ1 and the second threshold θ2. Although not illustrated, the pedal stroke amount θ only needs to be between the first threshold θ1 and the second threshold θ2 from the time point T22 to the time point T23, and thus may vary between the thresholds. After the time point T23, the pedal stroke amount θ returns to 0.

FIG. 9B illustrates how the braking force changes at the time of vehicle braking. From the time point T21 to the time point T22, the braking force increases with the pedal stroke amount θ. From the time point T22 to the time point T23, the pedal stroke amount θ is between the first threshold θ1 and the second threshold θ2. Here, it is assumed that the stop recognition device 42 has determined the presence of the vehicle stop information in the predetermined range in front of the vehicle at the time point T23. That is, between the time point T22 and the time point T23, the pedal stroke amount θ is between the first threshold θ1 and the second threshold θ2, and the presence of the vehicle stop information is not determined by the stop recognition device 42. Therefore, between the time point T22 and the time point T23, the ECU 20 executes the first braking force control to set the braking force to the predetermined braking force. Under the braking force control, the constant braking force control for setting the braking force constant is executed as in the first embodiment, whereby the braking force is kept constant.

At the time point T23, the pedal stroke amount θ is between the first threshold θ1 and the second threshold θ2, and the presence of the vehicle stop information is determined by the stop recognition device 42. Thus, the automatic stop mode is activated at and after the time point T23. The automatic stop mode is a control mode under which the vehicle smoothly stops at the target stopping position with the ECU 20 controlling the braking force, without requiring the driver to operate the brake pedal 31. Under the automatic stop mode illustrated in FIG. 9B, the braking force is changed to be smaller than the braking force under the constant braking force control, and the control force gradually decreases with the lapse of time. Then, the vehicle smoothly stops at the target stopping position.

FIG. 9C illustrates how the acceleration/deceleration G changes at the time of vehicle braking. From the time point T21 to the time point T22, the deceleration G increases with the braking force. Between the time point T22 and the time point T23, the braking force is maintained to be constant, and thus the deceleration G is constant. With the automatic stop mode being active at and after the time point T23, the deceleration G gradually decreases. At a time point T24, the vehicle smoothly stops, with the acceleration/deceleration G being extremely small.

FIG. 9D illustrates how the vehicle speed changes at the time of vehicle braking. The vehicle speed decreases from the time point T21 in response to an increase in the braking force. With the automatic stop mode being active at and after the time point T23 to make the braking force small, the decrease rate of the vehicle speed at and after the time point T23 is lower than that between the time point T22 and the time point T23. Then, the vehicle speed becomes 0 at the time point T24, and the vehicle stops at the target stopping position.

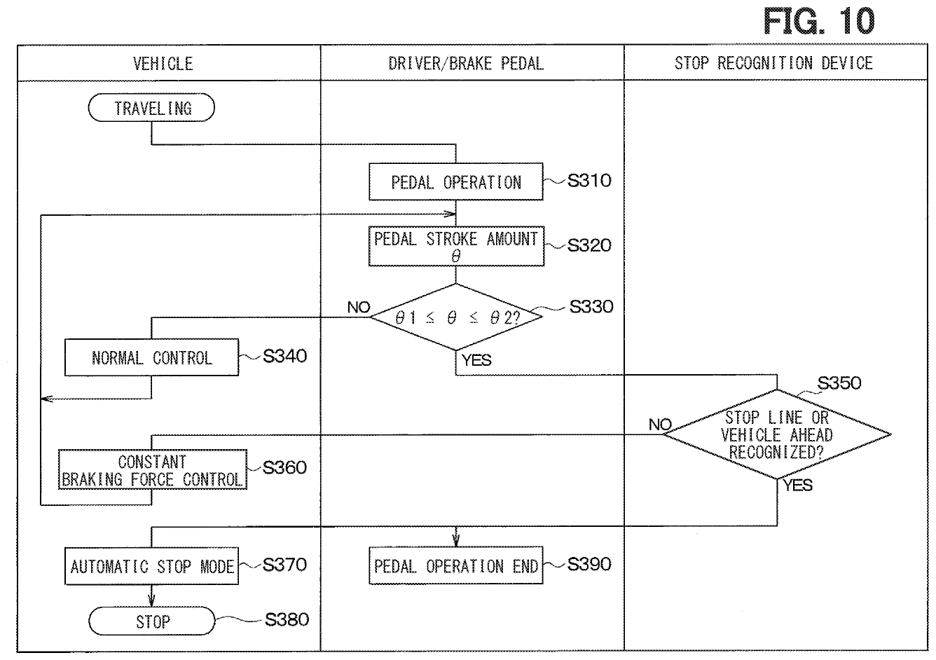

Next, control processing executed by the ECU 20 according to the third embodiment will be described with reference to a flowchart in FIG. 10.

The ECU 20 executes this control processing while the vehicle is traveling.

In step S310 in FIG. 10, in order to apply a brake to the vehicle, the driver applies pedal force to the brake pedal 31 and performs a depressing operation on the brake pedal 31. The sensor 32 of the brake device 30 outputs a signal corresponding to the pedal stroke amount θ to the ECU 20.

In step S320, the ECU 20 detects the pedal stroke amount θ from the output signal of the sensor 32.

Next, in step S330, the ECU 20 determines whether the pedal stroke amount θ is between the first threshold θ1 and the second threshold θ2. When the ECU 20 determines that the pedal stroke amount θ is not between the first threshold θ1 and the second threshold θ2 (that is, determines NO in step S330), the processing proceeds to step S340.

In step S340, the ECU 20 executes the normal control under which the braking force increases with the pedal stroke amount θ.

On the other hand, when the ECU 20 determines that the pedal stroke amount θ is between the first threshold θ1 and the second threshold θ2 in the processing in step S330 (that is, determines YES in step S330), the processing proceeds to step S350.

Next, in step S350, the ECU 20 determines whether the vehicle stop information (for example, a stop line or a vehicle ahead) is present in the predetermined range in front of the vehicle. When the ECU 20 determines that no vehicle stop information is in the predetermined range in front of the vehicle (that is, determines NO in step S350), the processing proceeds to step S360.

In step S360, the ECU 20 executes the braking force control. The braking force control is the constant braking force control under which the braking force is set to be constant. Then, the ECU 20 repeatedly executes the processing described in steps S320 to S360, at a predetermined control time interval while the vehicle is traveling.

On the other hand, when the ECU 20 determines that the vehicle stop information is present in the predetermined range in front of the vehicle in step S350 (that is, determines YES in step S350), the processing proceeds to step S370 and step S390.

In step S370, the ECU 20 activates the automatic stop mode. Under the automatic stop mode, the processing is executed to stop the vehicle smoothly at the target stopping position with the ECU 20 controlling the braking force, without requiring the driver to operate the brake pedal 31. When the vehicle stops in step S380 following step S370, the automatic stop mode is deactivated.

When the automatic stop mode is activated with the result of the determination in step S350 being YES, the driver may stop operating the brake pedal 31 in step S390. This is because when the automatic stop mode is activated, the ECU 20 controls the braking force to automatically stop the vehicle regardless of the output signal from the sensor 32.

The brake system 1 of the third embodiment described above also provides the same advantageous effects as those of the first embodiment, with the configuration and operation similar to those of the first embodiment. Furthermore, the third embodiment can provide the following advantageous effects.

(1) The ECU 20 of the brake system 1 of the third embodiment activates the automatic stop mode when the pedal stroke amount θ is between the first threshold θ1 and the second threshold θ2 and the vehicle stop information is in the predetermined range in front of the vehicle.

Thus, the brake system 1 activates the automatic stop mode based on the pedal stroke amount θ and the information transmitted from the stop recognition device 42. Once the automatic stop mode is activated, the vehicle automatically stops traveling with the ECU 20 controlling the braking force, without requiring the driver to operate the brake pedal 31. Thus, the brake system 1 requires no detailed operation on the brake pedal 31 by the driver to stop the vehicle traveling, and thus can improve operability of the brake pedal 31 and reduce the stress the driver feels when operating the brake pedal 31.

### Fourth to Ninth Embodiments

Fourth to ninth embodiments described below relate to the brake system 1 described in the first to third embodiments described above, having a function of notifying a driver of the execution of the braking force control and the like.

### Fourth Embodiment

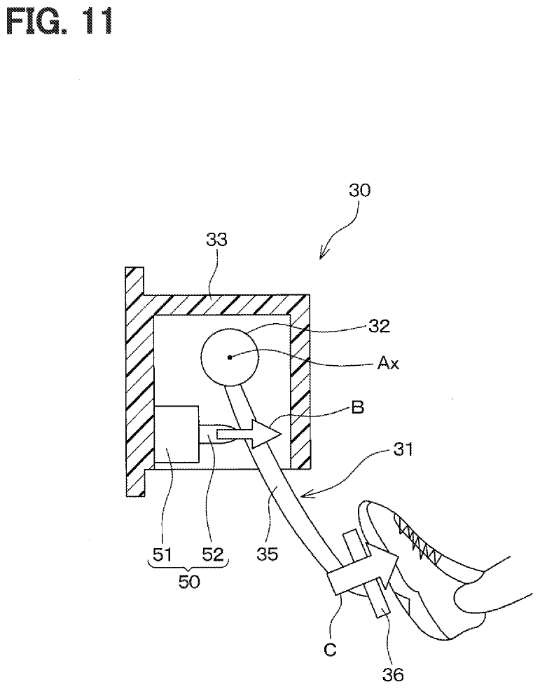

As illustrated in FIG. 11, the brake device 30 of the brake system 1 of the fourth embodiment includes an actuator 50 as a load application device. The actuator 50 includes a fixed portion 51 fixed to the support 33 and a protruding portion 52 protruding from the fixed portion 51 toward the brake pedal 31. The distal end of the protruding portion 52 can be in contact with the arm portion 35 of the brake pedal 31. The actuator 50 can apply a load in a direction opposite to the direction in which the pedal force is applied from the driver to the arm portion 35, by changing the amount of protrusion of the protruding portion 52 from the fixed portion 51 or pressing force by which the protruding portion 52 presses the arm portion 35. In FIG. 11, a direction in which the actuator 50 applies a load to the arm portion 35 of the brake pedal 31 is indicated by an arrow B. When the actuator 50 applies a load to the arm portion 35 of the brake pedal 31, the load is transmitted from the pedal portion 36 of the brake pedal 31 to the foot of the driver as indicated by an arrow C.

The ECU 20 operates the actuator 50 when the braking force control described in the first to the third embodiments is active or when the braking force control is deactivated. During then, the load applied to the brake pedal 31 by the actuator 50 is transmitted to the foot of the driver. Therefore, the driver can recognize that the braking force control is active or that the braking force control has been deactivated.

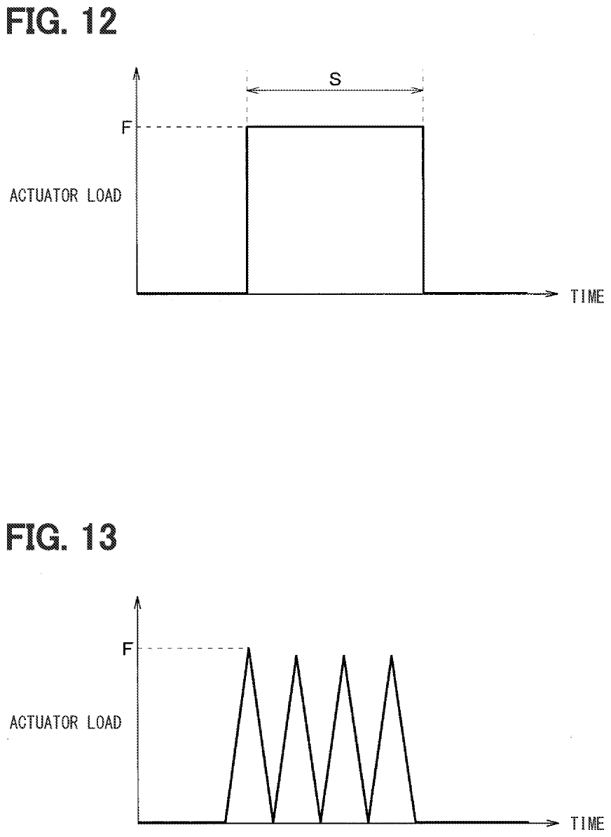

FIGS. 12 and 13 each illustrate an example of a method of applying a load from the actuator 50 to the brake pedal 31.

As illustrated in FIG. 12, the ECU 20 can continuously apply a constant load F to the brake pedal 31 for a predetermined period of time by driving the actuator 50 when the braking force control starts, when the braking force control is active, or when the braking force control is deactivated. In FIG. 12, the predetermined period of time is indicated by an arrow S. The magnitude of the load F and the predetermined period of time indicated by the arrow S can be arbitrarily set. The magnitude of the load applied when the braking force control starts, the magnitude of the load applied when the braking force control is active, and the magnitude of the load applied when the braking force control is deactivated may be different from each other.

As illustrated in FIG. 13, the ECU 20 can continuously apply the load F in a pulse form to the brake pedal 31 by driving the actuator 50 when the braking force control starts, when the braking force control is active, or when the braking force control is deactivated. Note that the load F in a pulse form can be applied at least once, and the magnitude of the load F and the number of times of application can be arbitrarily set. The magnitude of the load applied when the braking force control starts, the magnitude of the load applied when the braking force control is active, and the magnitude of the load applied when the braking force control is deactivated may be different from each other. Furthermore, by continuously applying the load in a pulse form a plurality of times, the notification can be issued to the driver through vibration applied to his or her foot.

The brake system 1 of the fourth embodiment described above also provides the same advantageous effects as those of the first embodiment and the like, with the configuration and operation similar to those of the first embodiment like. Furthermore, the fourth embodiment can provide the following advantageous effects.

(1) The brake device 30 of the brake system 1 of the fourth embodiment includes the actuator 50 as the load application device capable of applying a load in a direction opposite to the direction in which the pedal force is applied to the brake pedal 31 from the driver. The ECU 20 operates the actuator 50 when the braking force control is active or when the braking force control is deactivated.

With this configuration, the driver can be notified that the braking force control is active or that the braking force control is to be deactivated, using the actuator 50. Therefore, the driver can easily operate the brake pedal 31 as compared with the case where the driver operates the brake pedal 31 only with the feeling of depression (hereinafter, referred to as “depression feeling”). Thus, the brake system 1 can improve operability of the brake pedal 31 and reduce the stress the driver feels when operating the brake pedal 31.

(2) The ECU 20 of the brake system 1 of the fourth embodiment drives the actuator 50 to apply the constant load F to the brake pedal 31 for a predetermined period of time when the braking force control is active or when the braking force control is deactivated.

This also makes it easier for the driver to recognize that the pedal stroke amount θ is between the first threshold θ1 and the second threshold θ2 (that is, the braking force control range) and to hold the brake pedal 31 therebetween, as compared with the case of operating the brake pedal 31 only based on the depression feeling. Thus, the brake system 1 can improve operability of the brake pedal 31 and reduce the stress the driver feels when operating the brake pedal 31.

(3) The ECU 20 of the brake system 1 of the fourth embodiment drives the actuator 50 to apply a load in a pulse form to the brake pedal 31 at least once when the braking force control is active or when the braking force control is deactivated.

This also makes it easier for the driver to recognize that the pedal stroke amount θ is between the first threshold θ1 and the second threshold θ2 and to hold the brake pedal 31 therebetween, as compared with the case of operating the brake pedal 31 only based on the depression feeling. Thus, the brake system 1 can improve operability of the brake pedal 31 and reduce the stress the driver feels when operating the brake pedal 31. Furthermore, by continuously applying the load in a pulse form a plurality of times, vibration can be applied to the foot of the driver.

### Fifth Embodiment

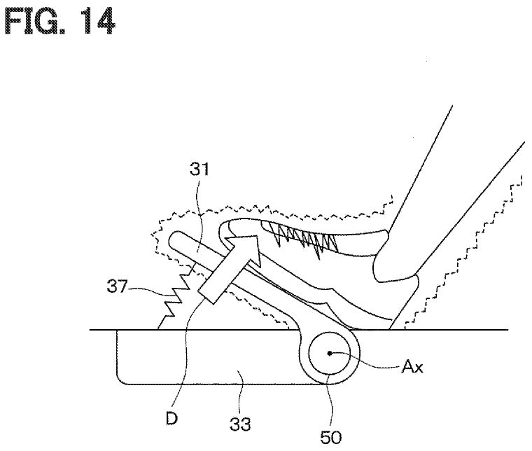

The fifth embodiment is different from the fourth embodiment described above in configuration of the brake device 30. Specifically, the brake pedal 31 described in the fourth embodiment is of a suspension type, and the brake pedal 31 described in the fifth embodiment is of an organ type as illustrated in FIG. 14.

As illustrated in FIG. 14, the brake device 30 of the brake system 1 of the fifth embodiment also includes the support 33, the brake pedal 31 operated by pedal force applied by the driver, a sensor (not illustrated) that outputs a signal corresponding to the stroke amount of the brake pedal 31, and the like.

The support 33 is attached to a part of the vehicle body on the front side of the cabin interior. Specifically, the support 33 is attached to, for example, a floor of the cabin interior. An end portion of the brake pedal 31 on the vehicle rear side is provided so as to be rotatable about the rotation axis Ax with respect to the support 33. When pedal force is applied to the brake pedal 31 from the driver, the brake pedal 31 is operated to be depressed about the rotation axis Ax.

The brake pedal 31 of the brake device 30 of the present embodiment is not mechanically connected to the hydraulic pressure generation device that generates hydraulic pressure in the brake circuit 10. Therefore, the brake device 30 includes the spring 37 as a reaction force generating member that generates reaction force of the brake pedal 31. Specifically, the spring 37 has one end connected to the brake pedal 31, and the other end connected to the support 33. As the spring 37, for example, any spring such as an equal interval spring, an unequal interval spring, or a two-stage spring can be used according to required pedal force characteristics.

The actuator 50 as a load application device is provided, for example, to the rotation axis Ax of the brake pedal 31. The actuator 50 can apply a load to brake pedal 31 in a direction opposite to a direction in which the pedal force is applied from the driver. In FIG. 14, a direction in which the actuator 50 applies a load to the brake pedal 31 is indicated by an arrow D. When the actuator 50 applies a load to the brake pedal 31, the load is transmitted from the brake pedal 31 to the foot of the driver. Note that the position at which the actuator 50 as the load application device is provided is not limited to the position on the rotation axis Ax illustrated in FIG. 14, and can be set to any position including, for example, a position more on the vehicle front side than the rotation axis Ax or the like.

The ECU 20 operates the actuator 50 when the braking force control described in the first to the third embodiments is active or when the braking force control is deactivated. Thus, the load applied by from the actuator 50 to the brake pedal 31 is transmitted to the foot of the driver. Therefore, the driver can recognize that the braking force control is active or that the braking force control has been deactivated.

The brake system 1 of the fifth embodiment described above also provides the same advantageous effects as those of the fourth embodiment, with the configuration and operation similar to those of the fourth embodiment. The organ-type brake pedal 31 described in the fifth embodiment can be applied to the brake system 1 described in any of the first to third embodiments and the brake systems 1 of sixth to eleventh embodiments described below.

### Sixth to Eighth Embodiments

In the sixth to the eighth embodiments, specific examples of a method of operating the actuator 50 described in the fourth and the fifth embodiments will be described.

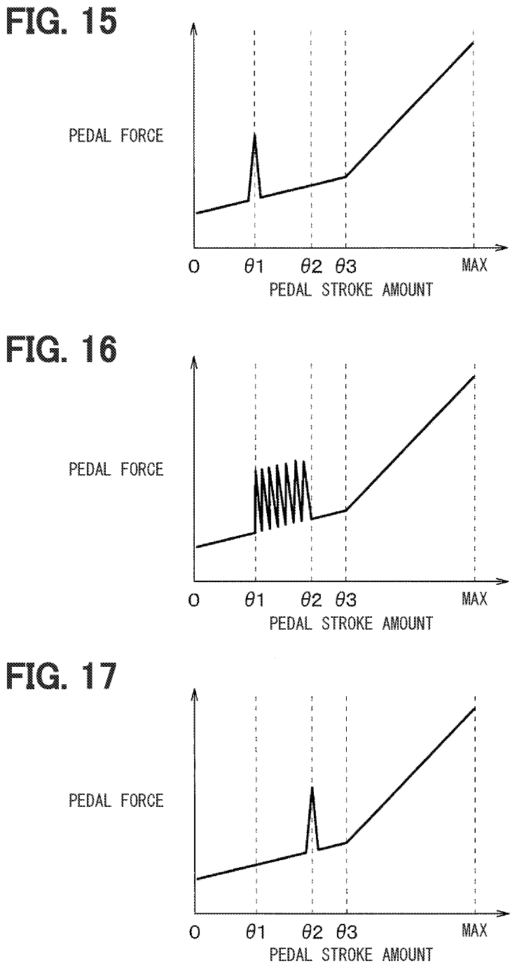

FIGS. 15 to 17 illustrate pedal force characteristics when the brake pedal 31 is depressed. In FIGS. 15 to 17, the horizontal axis represents the pedal stroke amount θ, and the vertical axis represents the pedal force (that is, the reaction force of brake pedal 31). Also in the sixth to the eighth embodiments, when the pedal stroke amount θ is between the first threshold θ1 and the second threshold θ2, the braking force control is executed as in the first to the third embodiments.

### Sixth Embodiment

As illustrated in FIG. 15, in the sixth embodiment, when the pedal stroke amount θ reaches the first threshold θ1, the ECU 20 drives the actuator 50 to apply a load to the brake pedal 31. As a load application method, the load in a pulse form may be applied at least once as illustrated in FIG. 13, or a constant load may be continuously applied for a predetermined period of time as illustrated in FIG. 12.

The brake system 1 of the sixth embodiment described above also provides the same advantageous effects as those of the first embodiment and the like, with the configuration and operation similar to those of the first embodiment like. Furthermore, the sixth embodiment can provide the following advantageous effects.

In the sixth embodiment, when the pedal stroke amount θ reaches the first threshold θ1, the actuator 50 applies a load to the brake pedal 31. With this configuration, using the actuator 50, the driver can be notified that the braking force control is activated with the pedal stroke amount θ entering the braking force control range from the state of being smaller than the first threshold θ1. Furthermore, using the actuator 50, the driver can be notified that the braking force control is deactivated due to the pedal stroke amount θ being smaller than the first threshold θ1 from the state of being within the braking force control range. Therefore, the driver can easily operate the brake pedal 31 as compared with the case where the driver operates the brake pedal 31 only with the depression feeling. Thus, the brake system 1 can improve operability of the brake pedal 31 and reduce the stress the driver feels when operating the brake pedal 31.

The magnitude of the load applied to the brake pedal 31 from the actuator 50 can be arbitrarily adjusted by the driver.

### Seventh Embodiment

As illustrated in FIG. 16, in the seventh embodiment, when the pedal stroke amount θ is between the first threshold θ1 and the second threshold θ2, the ECU 20 drives the actuator 50 to apply a load in a pulse form to the brake pedal 31 intermittently. Thus, the vibration can be transmitted to the foot of the driver.

The load application method is not limited to the one illustrated in FIG. 16, and a constant load may be continuously applied for a predetermined period of time.

The brake system 1 of the seventh embodiment described above also provides the same advantageous effects as those of the first embodiment and the like, with the configuration and operation similar to those of the first embodiment like. Furthermore, the seventh embodiment can provide the following advantageous effects.

In the seventh embodiment, when the pedal stroke amount θ is between the first threshold θ1 and the second threshold θ2, the actuator 50 applies a load to the brake pedal 31. With this configuration, using the actuator 50, the driver can be notified that the braking force control is active with the pedal stroke amount θ being between the first threshold θ1 and the second threshold θ2 (that is, the braking force control range). Thus, the driver can easily hold the brake pedal 31 between the first threshold θ1 and the second threshold θ2 (that is, within the braking force control range), as compared with the case of operating the brake pedal 31 only based on the depression feeling. Thus, the brake system 1 can improve operability of the brake pedal 31 and reduce the stress the driver feels when operating the brake pedal 31.

### Eighth Embodiment

As illustrated in FIG. 17, in the eighth embodiment, when the pedal stroke amount θ reaches the second threshold θ2, the ECU 20 drives the actuator 50 to apply a load to the brake pedal 31. As a load application method, the load in a pulse form may be applied at least once as illustrated in FIG. 13, or a constant load may be continuously applied for a predetermined period of time as illustrated in FIG. 12.

The brake system 1 of the eighth embodiment described above also provides the same advantageous effects as those of the first embodiment and the like, with the configuration and operation similar to those of the first embodiment like. Furthermore, the eighth embodiment can provide the following advantageous effects.

In the eighth embodiment, when the pedal stroke amount θ reaches the second threshold θ2, the actuator 50 applies a load to the brake pedal 31. Thus, using the actuator 50, the driver can be notified that the braking force control is deactivated due to the pedal stroke amount θ being larger than the second threshold θ2 from the state of being within the braking force control range. Furthermore, using the actuator 50, the driver can be notified that the braking force control is activated with the pedal stroke amount θ entering the braking force control range from the state of being larger than the second threshold θ2. Therefore, the driver can easily operate the brake pedal 31 as compared with the case where the driver operates the brake pedal 31 only with the depression feeling. Thus, the brake system 1 can improve operability of the brake pedal 31 and reduce the stress the driver feels when operating the brake pedal 31.

In FIGS. 15 to 17 referred to in the above-described sixth to the eighth embodiments, the rate of increase in pedal force, excluding the application of the load by the actuator 50, with respect to the pedal stroke amount θ is changed to be different before and after reaching a predetermined stroke value θ3. Specifically, the rate of increase in the pedal force with respect to the pedal stroke amount θ is relatively small until the predetermined stroke value θ3 is reached from 0 pedal stroke, and is relatively large in a range between the predetermined stroke value θ3 to the maximum value. Such pedal force characteristics can be achieved by using as the spring 37 serving as a reaction force generating member that generates the reaction force of the brake pedal 31, a two-stage spring, an unequally spaced spring, or the like with which elastic force (that is, pedal force characteristics) changes before the pedal stroke amount reaches the maximum value.

In the sixth to the eighth embodiments, the first threshold θ1 and the second threshold θ2 are each set to a value smaller than the predetermined stroke value θ3 at which the rate of increase in pedal force changes. Thus, the braking force control range (that is, between the first threshold θ1 and the second threshold θ2) in which the braking force control is executed by the ECU 20 is set to a range in which the rate of increase in pedal force with respect to the pedal stroke amount θ is relatively small. Thus, the driver can maintain the pedal stroke amount θ within the braking force control range (that is, between the first threshold θ1 and the second threshold θ2) using a relatively small pedal force, to keep the braking force control active.

### Ninth Embodiment

The brake system 1 of the ninth embodiment includes a display device 44 that provides display that can be visually recognized by the driver. The display device 44 includes, for example, a head-up display, a display provided on a meter panel and the like, or the like. The display device 44 displays the current pedal stroke amount θ as a result of the depression operation by the driver and the like.

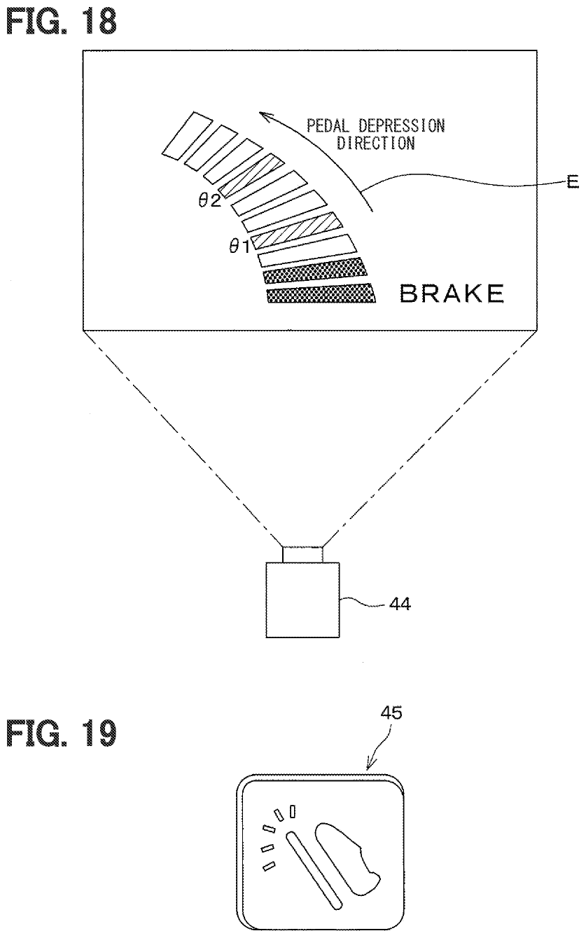

FIG. 18 illustrates an example of a design displayed on the windshield by the head-up display provided as the display device 44. In this design example, the pedal stroke amount θ is displayed in a plurality of stages (for example, 10 stages) represented by a plurality of frames arranged in a fan shape. In FIG. 18, the brake pedal 31 is depressed to the second stage, and this state is represented by a dotted frame. When the brake pedal 31 is further depressed to increase the pedal stroke amount θ, the dotted frame increases in the direction indicated by an arrow E.

The display device 44 displays a frame corresponding to the first threshold θ1 and a frame corresponding to the second threshold θ2 among the plurality of frames arranged in a fan shape so as to be distinguishable from other frames. In FIG. 18, the frame corresponding to the first threshold θ1 and the frame corresponding to the second threshold θ2 each are hatched. Note that the frame corresponding to the first threshold θ1 and the frame corresponding to the second threshold θ2 may be provided with predetermined colors, symbols, and the like to be distinguished from the other frames.

The brake system 1 of the ninth embodiment described above also provides the same advantageous effects as those of the first embodiment and the like, with the configuration and operation similar to those of the first embodiment like. Furthermore, the ninth embodiment can provide the following advantageous effects.

(1) The display device 44 of the brake system 1 of the ninth embodiment is configured to display the current pedal stroke amount θ, the first threshold θ1, and the second threshold θ2.

Thus, the driver can visually recognize the range in which the braking force control is executed according to the pedal stroke amount θ. Therefore, the driver can easily operate the brake pedal 31 as compared with the case where the driver operates the brake pedal 31 only with the depression feeling. Thus, the brake system 1 can improve operability of the brake pedal 31 and reduce the stress the driver feels when operating the brake pedal 31.

### Tenth Embodiment

The brake system 1 of the tenth embodiment further includes a switch 45 for switching whether or not to activate the control and the like described in the first to the ninth embodiments described above. The switch 45 may be provided, for example, at a location in the cabin interior to be operable by the driver, or may be configured with dedicated application software installed in a smartphone or an electronic key carried by the driver.

FIG. 19 illustrates a design example of the switch 45. In this design example, when the driver turns ON the switch 45 to permit the execution of the braking force control described above in the first to the third embodiments, a lamp in the switch 45 is configured to be turned ON. On the other hand, when the driver turns OFF the switch 45 to prohibit the execution of the braking force control described in the first to the third embodiments described above, the lamp in the switch 45 is configured to be turned OFF.

The brake system 1 may include a switch for adjusting a load of the actuator 50 described above in the fourth to the eighth embodiments, separately from the switch 45 illustrated in FIG. 19. The brake system 1 may further include a switch for switching whether or not to activate the displaying on the display described the ninth embodiments.

The brake system 1 of the tenth embodiment described above also provides the same advantageous effects as those of the first embodiment and the like, with the configuration and operation similar to those of the first embodiment like. Furthermore, the tenth embodiment can provide the following advantageous effects.

(1) The brake system 1 of the tenth embodiment includes a switch 45 for switching whether or not to activate the braking force control described above in the first to the third embodiments.

Thus, the driver can selectively use the braking force control by the ECU 20 and the braking by a brake pedal operation he or she performs, based on the driving condition and the like.

(2) The brake system 1 may include a switch for adjusting a load of the actuator 50 described in the fourth to the eighth embodiments. The brake system 1 may further include a switch for switching whether or not to activate the displaying on the display described the ninth embodiments. Thus, the preference of the driver can be satisfied.

(3) The switch 45 of the brake system 1 can be configured with dedicated application software installed in a smartphone or an electronic key that can be carried by the driver.

With this configuration, the brake system 1 can have the switch function at a low cost as compared with the case where the switch 45 installed in the vehicle.

### Eleventh Embodiment

The eleventh embodiment will be described. The eleventh embodiment is obtained by partially changing the configuration of the brake system 1 in the first embodiment and the like, and the other configuration is the same as that in the first embodiment and the like. Thus, only the part different from the first embodiment and the like will be described.

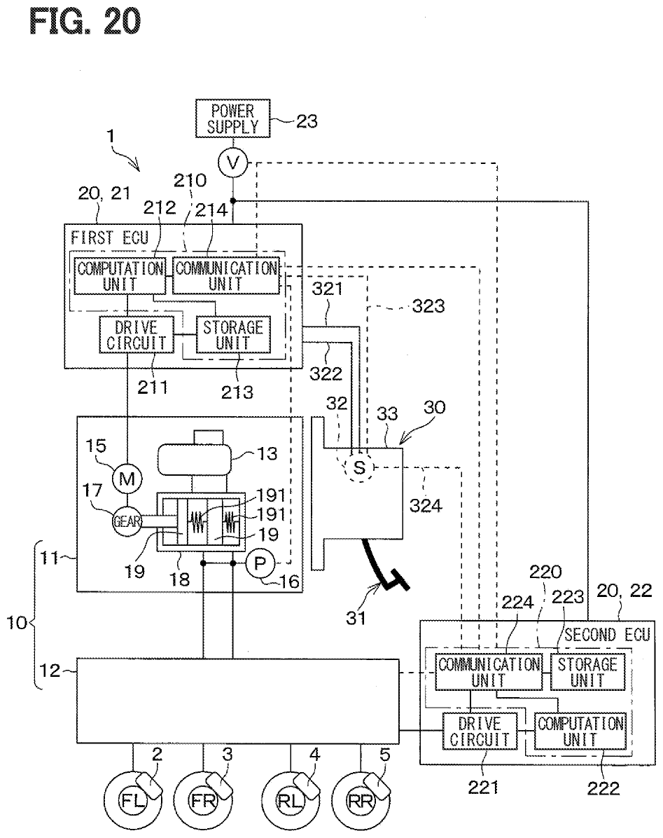

As illustrated in FIG. 20, in the brake system 1 of the eleventh embodiment, a configuration of the first brake circuit 11 is different from the configuration described in the first embodiment. The first brake circuit 11 of the eleventh embodiment includes the reservoir 13, the brake circuit motor 15, a gear mechanism 17, a master cylinder 18, the pressure sensor 16, and the like.

The reservoir 13 stores the brake fluid. The brake circuit motor 15 is rotationally driven by a drive signal from the first ECU 21, and transmits the resultant torque to the gear mechanism 17. The master cylinder 18 has a master piston 19, a master spring 191, and the like provided on the inner side thereof. The gear mechanism 17 makes the master piston 19 of the master cylinder 18 move back and forth in the axial direction of the master cylinder 18. The movement of the master piston 19 increases the hydraulic pressure of the brake fluid supplied from the reservoir 13 to the master cylinder 18. The resultant hydraulic pressure of the brake fluid is supplied from the first brake circuit 11 to the second brake circuit 12. The pressure sensor 16 outputs a signal corresponding to the hydraulic pressure of the brake fluid of the first brake circuit 11 to the first ECU 21.

The master cylinder 18 and the master piston 19 of the eleventh embodiment correspond to an example of the hydraulic pressure generation device that generates hydraulic pressure in the brake circuit 10. In the eleventh embodiment, the master cylinder 18 and the master piston 19 are not mechanically connected to the brake pedal 31 of the brake device 30.

The configuration and control of the brake system 1 described in the first to the tenth embodiments described above can be applied to the configuration of the brake system 1 of the eleventh embodiment.

The eleventh embodiment described above also provides substantially the same advantageous effects as those of the first embodiment and the like, with the configuration similar to that of the first embodiment like.

### Other Embodiments

(1) In each of the embodiments described above, the constant braking force control for keeping the braking force constant is described as an example of the braking force control executed when the pedal stroke amount θ is between the first threshold θ1 and the second threshold θ2, but the braking force control is not limited to this. For example, as the braking force control, the braking force may gradually decrease with the lapse of time.

(2) In each of the embodiments described above, the constant braking force control for keeping the braking force constant is described as an example of the braking force control executed when the pedal stroke amount θ is between the first threshold θ1 and the second threshold θ2, but the braking force control is not limited to this. For example, as the braking force control, braking force feedback-controlled may be performed to achieve constant deceleration G, or braking force feedback-controlled may be performed to gradually reduce the deceleration G with the lapse of time.

The present disclosure is not limited to the above-described embodiments, and can be appropriately changed.

In addition, the above-described embodiments are not exclusive to each other, and can be appropriately combined unless the combination is obviously impossible.

In each of the above embodiments, it goes without saying that the elements constituting the embodiments are not necessarily essential except for the cases where explicitly stated that the elements are particularly essential, the elements are considered to be obviously essential in principle, and the like.

In each of the above embodiments, when a numerical value such as the number, numerical value, amount, or range of the components of the embodiment is mentioned, the numerical value is not limited to a specific number unless otherwise specified as essential or obviously limited to the specific number in principle.

In each of the above embodiments, when referring to the shape, positional relationship, and the like of the components and the like, the components are not limited to the shape, positional relationship, and the like are unless otherwise specified or limited to a specific shape, positional relationship, and the like in principle.

The control unit and the method thereof described in the present disclosure may be realized by a dedicated computer provided by configuring a processor and a memory programmed to execute one or a plurality of functions embodied by a computer program. Alternatively, the control unit and the method thereof described in the present disclosure may be realized by a dedicated computer provided by configuring a processor with one or more dedicated hardware logic circuits. Alternatively, the control unit and the method thereof described in the present disclosure may be realized by one or more dedicated computers configured as a combination of a processor and a memory programmed to execute one or a plurality of functions and a processor configured by one or more hardware logic circuits. Furthermore, the computer program may be stored in a computer-readable non-transition tangible recording medium as an instruction executed by a computer.

What is claimed is:

1. A brake system installable in a vehicle, the brake system comprising:
a brake pedal operable by a pedal force of a driver;
a sensor capable of detecting a stroke amount of the brake pedal;
a brake circuit configured to apply a hydraulic pressure to a wheel cylinder provided to a wheel of the vehicle to generate a braking force to brake the vehicle;
a hydraulic pressure generation device configured to cause the brake circuit to generate a hydraulic pressure required to generate the braking force; and
an electronic control device configured to control driving of the hydraulic pressure generation device to control the braking force generated by the brake circuit, based on an output signal from the sensor and a state of the vehicle, wherein
the brake pedal is not mechanically connected to the hydraulic pressure generation device,
the electronic control device is configured to
control the hydraulic pressure generated by the hydraulic pressure generation device to execute a braking force control to set the braking force generated by the brake circuit to a predetermined braking force, when the stroke amount of the brake pedal is between a predetermined first threshold and a predetermined second threshold, which is larger than the first threshold, and
control the hydraulic pressure generated by the hydraulic pressure generation device to execute a normal control to set the braking force generated by the brake circuit to a braking force according to the stroke amount,
when the stroke amount of the brake pedal is smaller than the first threshold or
when the stroke amount of the brake pedal is larger than the second threshold.

2. The brake system according to claim 1, wherein
the braking force control is a constant braking force control to set the braking force generated by the brake circuit to a constant braking force.

3. The brake system according to claim 1, wherein
the electronic control device is configured to
execute a first braking force control to set the braking force generated by the brake circuit to the predetermined braking force,
when the stroke amount of the brake pedal is between the first threshold and the second threshold, and
when a vehicle speed is higher than a predetermined vehicle speed threshold, and
execute a second braking force control to change the braking force generated by the brake circuit to a braking force smaller than the braking force under the first braking force control,
when the stroke amount of the brake pedal is between the first threshold and the second threshold, and
when the vehicle speed is below the vehicle speed threshold.

4. The brake system according to claim 1, wherein
a stop recognition device configured to recognize a sign or an object in front of the vehicle, and
the electronic control device is configured to
execute the braking force control to set the braking force generated by the brake circuit to the predetermined braking force,
when the stroke amount of the brake pedal is between the first threshold and the second threshold, and
when a sign or an object, which causes determination to stop the vehicle, is not in a predetermined range in front of the vehicle, and
execute an automatic stop mode to automatically control driving of the brake circuit to stop the vehicle,
when the stroke amount of the brake pedal is between the first threshold and the second threshold, and
when the sign or the object, which causes determination to stop the vehicle, is in the predetermined range in front of the vehicle.

5. A brake system installable in a vehicle, the brake system comprising:
a brake pedal operable by a pedal force of a driver;
a sensor capable of detecting a stroke amount of the brake pedal;
a brake circuit configured to cause application of a hydraulic pressure to a wheel cylinder provided to a wheel of the vehicle to generate a braking force to brake the vehicle;
an electronic control device configured to control the braking force generated by the brake circuit, based on an output signal from the sensor and a state of the vehicle; and
a load application device capable of applying a load in a direction opposite to a direction of application of the pedal force of the driver to the brake pedal, wherein
the electronic control device is configured to execute a braking force control to set the braking force generated by the brake circuit to a predetermined braking force, when the stroke amount of the brake pedal is between a predetermined first threshold and a predetermined second threshold, which is larger than the first threshold, and
the electronic control device is configured to operate the load application device, under the braking force control or when deactivating the braking force control.

6. The brake system according to claim 5, wherein
the electronic control device is configured to cause the load application device to continuously apply a constant load to the brake pedal for a predetermined period of time, under the braking force control or when deactivating the braking force control.

7. The brake system according to claim 5, wherein
the electronic control device is configured to cause the load application device to apply a load in a pulse form to the brake pedal at least once, under the braking force control or when deactivating the braking force control.

8. The brake system according to claim 5, wherein
the electronic control device is configured to cause the load application device to apply a load to the brake pedal, when the stroke amount of the brake pedal reaches the first threshold.

9. The brake system according to claim 5, wherein
the electronic control device is configured to cause the load application device to continuously or intermittently apply a load to the brake pedal, when the stroke amount of the brake pedal is between the first threshold and the second threshold.

10. The brake system according to claim 5, wherein
the electronic control device is configured to cause the load application device to apply a load to the brake pedal, when the stroke amount of the brake pedal reaches the second threshold.

11. The brake system according to claim 1, further comprising:
a display device configured to provide display viewable by a driver, wherein
the display device is configured to display the stroke amount of the brake pedal at current timing, the first threshold, and the second threshold.

12. The brake system according to claim 1, further comprising:
a switch to switch whether or not to execute at least one of the braking force control and the normal control.

13. The brake system according to claim 2, further comprising:
a switch to switch whether or not to execute at least one of the constant braking force control and the normal control.

14. The brake system according to claim 3, further comprising:
a switch to switch whether or not to execute at least one of the braking force control, the normal control, the first braking force control, and the second braking force control.

15. The brake system according to claim 4, further comprising:
a switch to switch whether or not to execute at least one of the braking force control, the normal control, and the automatic stop mode.

16. The brake system according to claim 12, wherein
the switch is configured with a dedicated application software installable in a smartphone or an electronic key that is able to be carried by the driver.
